(19) United States
(12) Patent Application Publication
(10) Pub. No.: US 2011/0104653 A1
(43) Pub. Date: May 5, 2011

(54) INTERACTIVE DIGITAL WORKBOOK SYSTEM AND METHOD

(75) Inventors: Christopher Rogers, Lincoln, MA (US); Ethan Danahy, Cambridge, MA (US)

(73) Assignee: TUFTS UNIVERSITY, Boston, MA (US)

(21) Appl. No.: 12/673,678

(22) PCT Filed: Jan. 7, 2009
(86) PCT No.: PCT/US09/30260

§ 371 Date: Feb. 16, 2010

Related U.S. Application Data
(60) Provisional application No. 61/019,508, filed on Jan. 7, 2008.

(51) Int. Cl. G09B 3/00

(52) U.S. Cl. 434/350

(57) ABSTRACT

A digital workbook program, method, and system include a program interface module configured to communicate with a set of applications and a workbook module configured to generate a digital workbook from a master digital workbook. The digital workbook includes content and mechanisms that enable inputs to and receipt of outputs from the set of applications. Also included are a user interface module configured to generate user interface screens within which the digital workbook is presented and a storage module configured to store the digital workbook with user-entered inputs and outputs from the set of applications. The applications can communicate with a set of devices. Also, the digital workbook program, method, and system can be configured to enable authoring of digital workbooks and presentation in a visual library, as well as analysis of user specific digital workbooks.

### FIELD OF INTEREST

The present inventive concepts relate to the field of computer programs and applications, and related systems and methods, and more particularly to the field of computer programs, systems, and methods for creating digital workbooks.

### BACKGROUND

Many computer programs are interactive, enabling a user to generate and read electronic documents including various types of content. As an example, a word processing program can enable a user to create an electronic document that includes rich text. That same word processing program could also enable a user to add to the document graphics, audio files, video files, and HTML (hypertext markup language) links. To a limited degree, content from other applications can be merged into a word processing document. For example, a spreadsheet or graph can be merged into a word processing document from a spreadsheet program. In the word processing document the spreadsheet is static content—unchanging and generally unaffected by the user's interaction with the document.

To the extent interaction with the static spreadsheet is possible, it includes “opening” the spreadsheet, which temporarily transitions the user to the spreadsheet program. Within the spreadsheet program the user can, perhaps, perform spreadsheet edits by changing data, for example. When the user closes the spreadsheet program the user is transitioned back to the word processing program where the updated spreadsheet is then presented—again in static form. Thus, the user migrates from the word processing program window to the spreadsheet program window and back again. The access to multiple programs is done in a serial manner.

When a URL (uniform resource locator), for example, is present in an electronic document of a program, e.g., a word processing program, e-mail program or the like, selection of the URL transitions the user to the indicated page. Here again, the user is transitioned from a first location (e.g., page, document, or program) to another location—in a serial manner. While this has been perfectly adequate in general, it does pose some limitations. For example, a fully interactive electronic document that brings a variety of applications together in a comprehensive manner is not possible.

Web browsers are considered highly interactive programs, and thus widely used. A Web browser can display a Web page that includes a variety of types of static and dynamic content. For example, a browser can present text, such as articles, and simultaneously present “flash” content, such as pop-ups and ads. Dynamically changing real-time, or near-real-time, data can also be presented via the browser, such as stock tickers, temperature readings, or streaming video from a video camera.

Web pages are interactive in that the user can migrate from page to page, input data (e.g., to make purchases, blog, etc.), play available audio and video files, download and upload files. However, web browsers typically push content to a user, and do not generally solicit much user input from a content perspective. While it is true that a user can click and, for example, enter a name or other such information, primarily the user is having the content delivered (or pushed) to it, not interacting, or even better, adding to the content.

A Web browser is not well suited to be an authoring or content creation tool—it does not readily enable a user to create content or edit existing content. While some community-based sites, social networking sites, and blogging sites allow users to post content—there is actually not much flexibility for the user regarding those inputs. Part of the reason for this is that web browsers are inherently limited due to the security restrictions put in place. The browser itself can only do so much (and is aided by Flash plug-ins, Java plug-ins, etc). Postings and uploads may be allowed, but beyond that interactive electronic document and the like are not generally possible.

Certain specialized programs enable a user to create programs that can control devices, such as ROBOLAB™ by Tufts University. As an example, ROBOLAB provides a graphical interface that enables a user to generate a program that controls a physical device, i.e., a LEGO® “brick” (LEGO is a registered trademark of The LEGO Group). A LEGO brick is a LEGO component that includes a processor capable of executing a user-created program, downloaded from a computer, to control a physical device, such as a motor. Using ROBOLAB and LEGO components educators can have students write programs that demonstrate, or otherwise promote the learning of, certain engineering or scientific principles. While this is a useful tool, such programs are not particularly contextual or comprehensive. That is, a teacher and student are not able to reflect a lesson and the student's performance in any comprehensive manner, such as an interactive digital workbook that provides instructions and also serves as a record of the student's activities in performing the lesson. Thus, while useful, significant limitations exist in such programs.

None of the foregoing forms of computer programs or systems enable user creation of static and dynamic content, historical recording of user interaction, generation of command, control, or program instructions, and execution thereof within a context-oriented interactive digital workbook, for example.

### SUMMARY OF INVENTION

In accordance with one aspect of the present disclosure, provided is a digital workbook system. The system comprises a workbook module configured to enable an author to generate a digital workbook through a graphical framework configured to enable the author to generate pages within the digital workbook. The pages include interfaces to a set of applications and mechanisms that facilitate user interaction with the set of applications and recording user entries and of information from the set of applications. The system also includes a storage module configured to store the digital workbook in an electronic library as a master digital workbook.

The workbook module can be configured to enable the author to enter programming instructions to interact with at least one external device via the set of applications through the digital workbook.

The mechanisms that facilitate user interaction with the set of applications and recording of user entries and information from the set of applications can include mechanisms that enable the user to graphically define and interact with a computer program configured to control an external device.

The system can further include a collaboration module configured to enable multiple authors to create a digital workbook simultaneously using different computers.

The pages can further include information and instructional content including one or more of textual, graphical, audio, or video content.

The interfaces to the set of applications can include application program interfaces that enable the workbook module to communicate with the set of applications.

The system can further include an interaction module configured to enable the user to generate and save a unique digital workbook from the master digital workbook and to record the user entries and information from the set of applications as part of the unique digital workbook.

In accordance with another aspect of the invention, provided is a digital workbook system. The system comprises: a program interface module configured to communicate with a set of devices; a workbook module configured to generate a digital workbook from a master digital workbook, the digital workbook comprising content including mechanisms that enable inputs to and receipt of outputs from the set of devices; a user interface module configured to generate a user interface screen within which the digital workbook is presented; and a storage module configured to store the digital workbook with user-entered inputs and outputs from the set of devices as part of the content. The digital workbook takes the form of a user specific electronic book that documents the user's interaction therewith.

At least a portion of the content can be dynamic information, including selectable icons and hypertext links.

The mechanisms enabling input can include a palette of drag-and-drop icons representing instructions for programming at least one of the set of devices.

The mechanisms enabling input can include alphanumeric input boxes configured for user data entry.

The mechanisms enabling input can enable at least one of an audio input, a video input, and a camera input.

The user-entered inputs can include user-entered programming instructions passed to the set of devices through the program interface module.

The mechanisms enabling receipt of outputs from the set of devices can include data and information recording mechanisms.

The mechanisms enabling receipt of outputs from the set of devices can include mechanisms for generating a graph from sensor data output from the set of devices.

The system can further comprise a collaboration module configured to enable multiple users to interact with the digital workbook using different computers.

The digital workbook can be an educational lesson or lab and the multiple users can include at least two students.

The digital workbook can be an educational lesson or lab and the multiple users can include a teacher and a student.

In accordance with another aspect of the invention, provided is a computer-based method of creating and storing a digital workbook. The method comprises: providing an electronic library having at least one master digital workbook; generating the digital workbook from the master digital workbook, the digital workbook comprising content including mechanisms that enable inputs to and receipt of outputs from a set of applications; interacting with the set of applications from within the digital workbook; and storing the digital workbook with user-entered inputs and outputs from the set of applications as part of the content.

The set of applications can control at least one external device that generates at least some of the outputs.

The interacting can include programming the at least one external device from within the digital workbook.

The at least one external device can include at least one programmable device.

In any of the foregoing, where there are external devices, such external devices can include one or more of a robotic apparatus, motor, camera, light, transmitter, receiver, sensor, or other controllable device, system, or apparatus.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 is a block diagram of an embodiment of an interactive digital workbook system in accordance with aspects of the present invention;

FIG. 2 is a block diagram that includes a more detailed embodiment of the digital workbook program 100 of FIG. 1;

FIGS. 3-12 are screenshots of an illustrative education embodiment of the interactive digital workbook system of FIGS. 1 and 2;

FIGS. 13A-22B are screenshots of an embodiment of screens of a digital workbook from FIG. 3;

FIG. 23 is a screenshot of an embodiment of a main screen that can be used for creating a digital workbook;

FIG. 24 is a screenshot of an embodiment of an editing screen that can be used for editing text in a digital workbook;

FIG. 25 is a screenshot of an embodiment of an editing screen that can be used for editing an image in a digital workbook;

FIG. 26 is a screenshot of an embodiment of an editing screen that can be used for editing a graph element in a digital workbook;

FIG. 27 is a screenshot of an embodiment of an editing screen that can be used for editing interactive code elements in a digital workbook;

FIG. 28 is a screenshot of an embodiment of an editing screen that can be used for editing a data set element in a digital workbook; and

FIG. 29 is a screenshot of the main screen of FIG. 23 with a markup language tab selected.

### DETAILED DESCRIPTION OF PREFERRED EMBODIMENT

Hereinafter, aspects of the present invention will be described by explaining illustrative embodiments in accordance therewith, with reference to the attached drawings. While describing these embodiments, detailed descriptions of well-known items, functions, or configurations are typically omitted for conciseness.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Herein described are embodiments of a digital workbook system, method, and computer program product. The foregoing can be used to generate a digital workbook. Users can create their own copies of the workbook and recorded their interactions therewith—as part of their digital workbook. The digital workbook can be self-guided to direct the user's interaction. Digital workbooks can be customized for personal preferences, changes in circumstances, local standards, or as otherwise useful. Data from digital workbooks can be accessed, combined, analyzed, and operated on to obtain findings over a group of digital workbooks.

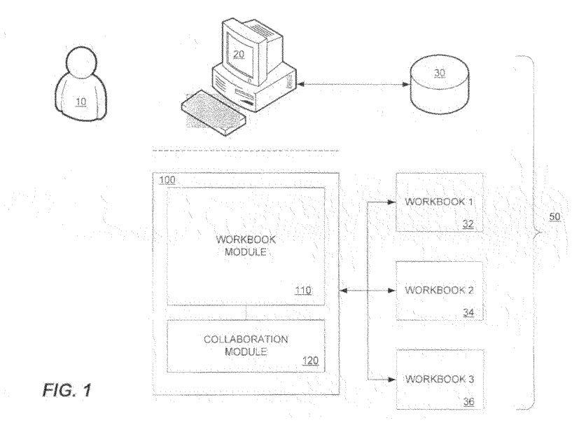

FIG. 1 is a block diagram of an embodiment of an interactive digital workbook system 50 in accordance with aspects of the present invention. The interactive digital workbook system 50 brings together many different technologies into one location, providing content developers an easy authoring environment and end-users an engaging environment for progressing through the content and manipulating a variety of software and/or hardware (locally or remotely) simultaneously.

In this embodiment, the interactive digital workbook system 50 includes data storage media 30, and an interactive digital workbook computer engine 100 (or program). The digital workbook system 50 can be accessed by one or more types of computers, e.g., personal computer 20. The interactive digital workbook system 50 enables a user 10 operating computer 20 to generate and customize digital workbooks, as well as interact with such digital workbooks, such as interactive digital workbooks 32, 34, and 36 in FIG. 1. Optionally, collaboration on an interactive digital workbook can also be enabled. Different types of users can have different levels of access to and interaction with the digital workbook system 50.

While a PC 20 is used in this embodiment as an example of a computer, any computing device comprising at least one processor could be used, such as a “Mac” computer, personal digital assistant (PDA), cell phone, or the like.

The digital workbook engine 100 can take the form of (or include) a computer program that comprises computer readable instructions capable of being executed by one or more processors and may be stored in one or more storage devices or systems (e.g., in storage media 30). In some embodiments the digital workbook engine 100 may be implemented in a client-server or other configuration where computer 20 (and other computers) access digital workbook engine functionality via a network, e.g., via a browser or other client-side application. In this embodiment, the digital workbook engine 100 comprises a workbook module 110 and a collaboration module 120. The workbook module 110 includes functionality for generating, customizing, and interacting with one or more of the digital workbooks 32, 34, and 36. For example, one type of user may author a digital workbook and another type of user or users may interact with an instance of the digital workbook, and still another type of user may review the and evaluate the interaction and optionally add evaluative or corrective feedback to the interacted with instance of the digital workbook.

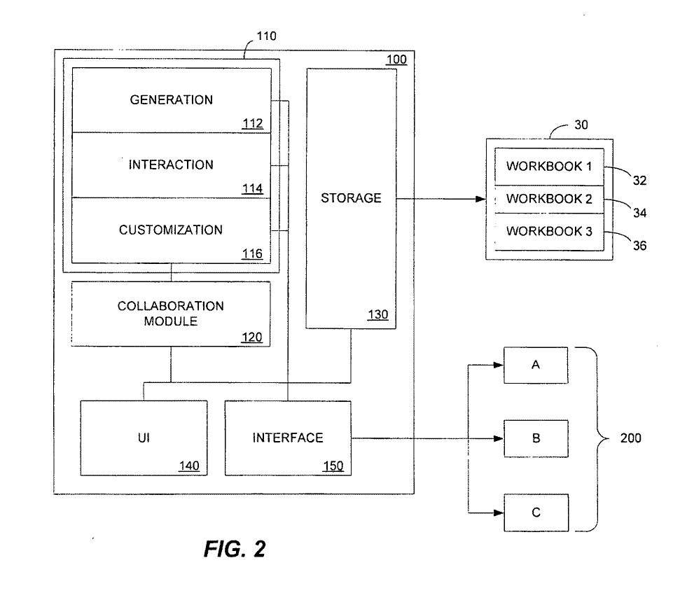

FIG. 2 is a block diagram that includes a more detailed embodiment of the digital workbook engine 100 of FIG. 1.

In the embodiment of FIG. 2, the workbook module 110 includes a generation module 112, an interaction module 114, and a customization module 116. The generation module 112 enables a user to create, from scratch, a digital workbook, e.g., workbook 1. That is, the user 10 opens the digital workbook engine 100 using computer 20 and is provided with a window or screen that enables the user to open an existing workbook or to create a new workbook. Therefore, a user interface (UI) module 140 is provided to facilitate such interaction.

Using the generation module 112 the user, as an author, can create a new workbook. This can include adding un-editable information in the workbook, such as text, graphics, audio, video and the like. Such un-editable information can include, for example, instructions to be used by subsequent users of the workbook being created. This can also include adding mechanisms for enabling a user to provide inputs to and receive outputs from external sources (e.g., applications, devices, information providers). For example, user inputs can include alphanumeric, audio, video, or camera inputs. Outputs can be received from other applications and/or external devices, e.g., sensors, systems, and data sources. The author can also provide mechanisms to enable a user to provide instructions to another application or external device that provides control or solicits information or other outputs from the external device or in relation thereto.

In FIG. 2, such other applications and/or external devices 200 are shown as blocks A, B, and C. For example, blocks A, B, and C could represent a drawing or spreadsheet application, a physical system or sensor (e.g., motor, robot, digital thermometer, or pressure sensor), or a database or data stream of information. Communication with blocks A, B, and C is accomplished using an interface module 150. The interface module 150 can be configured to provide an interface to any application, device, and/or data source—as appropriate for the digital workbook.

Thus, using generation module 112, a new workbook can be created, e.g., workbook 1. The workbook can be interactive in that the author could have provided instructions and information for a subsequent user that requires communication with blocks A, B, and C—as well as user inputs. The user could follow the instructions, provide or obtain inputs for blocks A, B, and C, and those inputs can be recorded in an instance of the workbook for that user. To the extent outputs are received from the blocks A, B, and C those can be also recorded in the workbook. The user's instance of the workbook can then be saved with the user's interactions and received information recorded therein.

Therefore, in some embodiments, the author created workbook can serve as a master workbook and each subsequent user can create a copy of the workbook, as an instance of the workbook, that is unique to that user and reflects that user's inputs and interaction therewith. Accordingly, different users could have their own unique saved instances of workbooks 1, 2, and/or 3.

The collaboration module 120 can provide the ability to enable multiple authors to create a workbook together—from different computers. The collaboration module 120 can also enable multiple users to jointly interact with a digital workbook—such as with a group project. The computers of such users can be co-located or widely dispersed—such that at least one is considered remote. For example, different users in different places could access and interact with the same master workbook to create their own instances. Otherwise, different users in different places could interact with the same instance of a workbook in a collaborative or competitive effort.

The interaction module 114 enables a subsequent user to open a workbook and interact with it. Preferably, a copy of the workbook is created that is unique to the user, as mentioned above. Therefore, the user's inputs and outputs from blocks A, B, and/or C are stored in that user's workbook. Programs or instructions written by the user and data collected and entered by the user are also stored as part of the workbook. This has wide application. For example, in a classroom setting a master workbook representing a lab or lesson can be stored and accessible by students in a class. Each student can open the master and save a copy of it's own. Thereafter, each student creates a unique workbook that reflects that student's interaction over the course of performing the lesson. The teacher could then review each student's workbook and provide feedback within the workbook. The teacher could also monitor several workbooks during performance of the lesson, in real time, to determine if a student has gone astray or is not keeping up.

Similar scenarios can be conceived in corporate and military training and maintenance contexts—as examples. For example, a workbook could be established for performing maintenance on a vehicle. A vehicle technician could use the workbook to perform diagnostics, and record those results, input observations, and save the vehicle workbook in a vehicle history library. In some settings, the vehicle could automatically send performance and status information to the vehicle workbook during normal use. In a corporate setting, an employee history and performance workbook can be created that records performance evaluations, achievements, etc. and also records information related to projects on which the employee had a significant role. A project workbook can be created with schedule, budget, and resource plans and data can be sent to the project workbook from various sources providing actuals against the plans; the workbook could then be viewed by program managers and their supervisors, auditors, and so on.

The customization module 120 can provide rights and privileges that are not as great as those provided by the generation module 112, but more than those provided by the interaction module 114. The customization module 116 allows edits to the workbook, beyond making the inputs enabled by the interaction module 114. For example, the customization module 116 could enable a teacher to tailor a workbook specifically for its class, e.g., by editing, adding or deleting text, and/or the mechanisms enabling inputs and outputs.

Below is described an illustrative embodiment targeted to the educational community, but its uses are in no way limited to academia and are not restricted to use only by students and teachers. However, many of the concepts and descriptions contained within this workbook are presented from that perspective for illustration, and not as a limitation.

Within the classroom specifically, the interactive digital workbook system 50 can accomplish at least three major goals: classroom management, increased interaction, and simple customization.

Classroom Management:

Within the classroom, the interactive digital workbook system 50 can assist with various aspects of classroom management.

The interactive digital workbook system 50 can dynamically detect, fix, and guide users (e.g., students) through the process of recovering from technology, software, and hardware issues. Through dynamic tracking of a user's progress, the workbook will be able to guide the user when problems are detected.

The workbooks can provide a recipe to assist teachers with managing the classroom. The activities in the workbook can be self-guided, alleviating the teacher from having to separately work with each student group simultaneously, and instead the book can do the presenting of ideas and directed instruction allowing the teacher to handle the class easier.

Through the increased interaction and simple customization, the teachers will be more satisfied with the curriculum and more likely to not only use pre-existing material, but can alter it to their needs, thus making the learning environment smoother.

The interactive digital books will help motivate and encourage students (thus, they will be more focused) in the activities. When compared to traditional paper handouts, the digital workbooks will not only excite the students, but will provide a more tailored learning experience using dynamic customization.

Increased Interaction:

There are several levels of increased interaction that the interactive digital workbook system 50 can facilitate.

Between students and technology, the interactive digital workbook system 50 will eliminate many hardware handicaps by facilitating the process of getting up and running. It will open up the possibilities of incorporating many new pieces of software and various hardware setups into the curriculum—due to its ease of use. This will lead to better comprehension and development of the conceptual connection between the pieces of technology in use.

Between students and their work, the digital workbooks will give an increased sense of ownership and the students become more invested in their work. They, in essence, become the authors of their own digital workbook, subject to restrictions imposed by the environment. However, the more latitude they have, the more engaged they become and, in the end, become more connected to the educational concepts covered.

Between students, there is the possibility of increased collaboration within a group, in addition to the sharing of digital workbooks between students in the same class. This can extend further to outside the classroom, as groups can share their work with others located remotely. This also leads to increased excitement in their work as they not only strive to produce a more professional product (which they know will be seen by others), but also leads to inspiration and motivation through the viewing of their peers work. Finally, this same model can be used between the students and their parents, as there becomes increased interaction when the student can share a digital portfolio of his/her work with a parent at the end of the day.

Between students and teachers, the interactive digital workbook system 50 provides increased interaction by facilitating both the submissions of assignments, as well as the grading, commenting, and returning of completed books. Further, with digital copies of the assignments stored in a specific location, the organization (and subsequent evaluation) of the entire course of work is improved.

Between teachers, there is an increased level of sharing of ideas and concepts with regard to the teacher practice as curriculum and activities are shared. The downloading, customization, and uploading of modified content adds to the collective worldwide resource of available material. Similar to the student-student interaction, the teachers can become inspired similarly through the use of other teachers' ideas and concepts.

Simple Customization:

Several areas of customization are made easier through the use of the interactive digital workbook system 50 (see customization module 116). The system provides teachers with an environment for easy customization activities based on personal preferences, classroom learning styles, local standards, personal language, etc. From the student's perspective, they now will be able to generate more personal reports of their work, incorporating both real-time/real-world data, as well as multimedia elements into their projects.

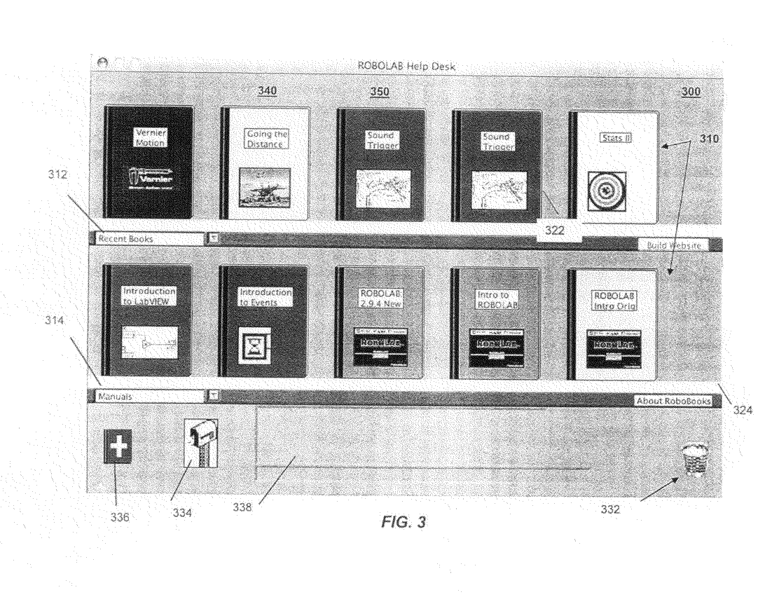

FIGS. 3-12 are screenshots of an illustrative education embodiment of the interactive digital workbook system 50 of FIGS. 1 and 2. FIGS. 3-12 are screenshots presented to a user interacting with a digital workbook using the interaction module 114. As will be apparent, the user interface module 140 generates the screens and the interface module 150 communicates with external devices 200.

FIG. 3 is a screenshot of a bookshelf screen 300 that shows a set of icons representing digital workbooks 310 that can be selected by a user. In this embodiment, pull-down menus 312 and 314 enable a user to select the digital workbooks that will be displayed on the bookshelves 322 and 324. Digital workbooks can also be put in the trash from this screen as indicated by icon 332 and they can be e-mailed as indicated by icon 334.

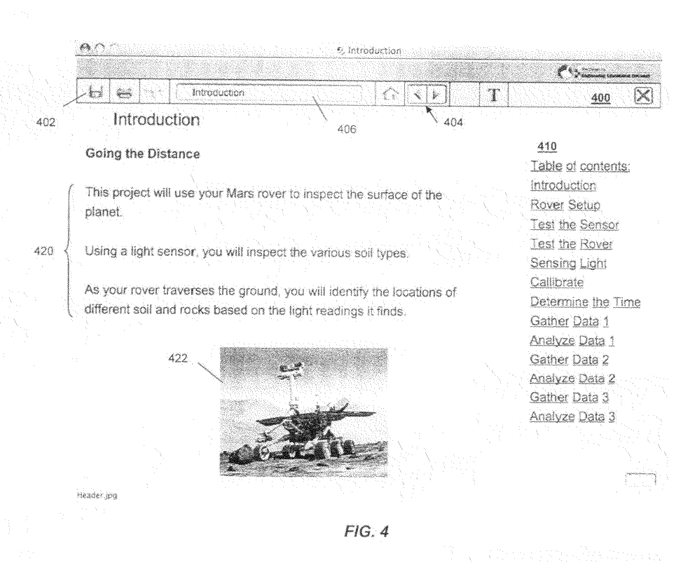

Presuming that digital workbook 340, entitled Going the Distance, was selected the screen 400 of FIG. 4 is presented. For example, double-clicking on the digital workbook icon 340 can cause a copy (or instance) of the workbook to be opened. Screen 400 represents the first screen or page in the selected digital workbook 340. A page header 402 is provided and includes, among other things, navigation arrows 404 and a section field 406 indicating the section of the workbook being viewed, here “Introduction.”

A table of contents 410 is presented on the screen that enables a user to navigate throughout the workbook, by showing pages and/or sections of the workbook as user selectable internal document links. The first screen presented is the Introduction, which is also the first item in the “Table of contents.” In this screen there is introductory text 420 that communicates to the user some basic information about the lesson or lab. This text is not, in this case, editable by the student user. A picture 422 related to the lesson is also provided.

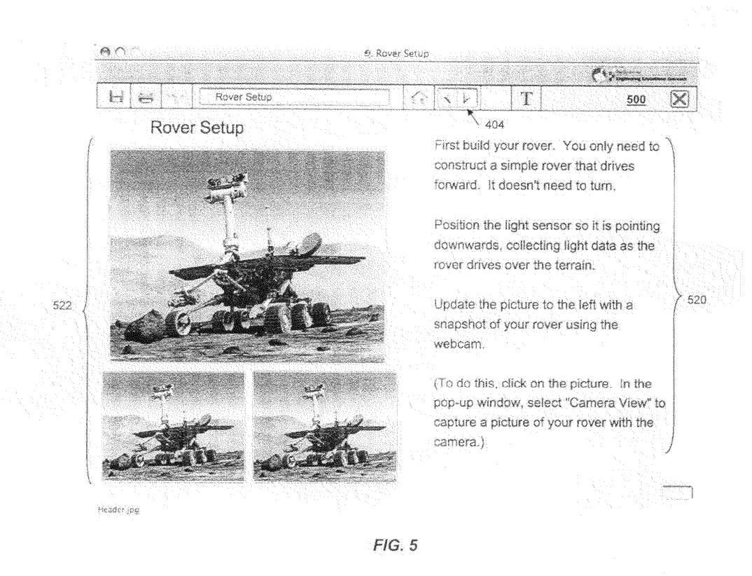

The user can then migrate to FIG. 5, which is a page called “Rover Setup.” The migration can occur through arrows 404 in the header or by selecting the “Rover Setup” link in the table of contents of the screen of FIG. 4. This screen provides further instructional text 520 to guide the user. That is, in this embodiment the user has built a rover that can be interfaced with the interactive digital workbook system 50, e.g., as device A in FIG. 2. This screen also provides a set of rover images 522. The user is invited to replace those pictures with pictures of his own rover. This can be done by selecting one of the three pictures, and then taking a picture of the user-built rover with a digital camera attached to the user's computer. In this embodiment, the picture automatically replaces the user selected picture. The camera can be considered an external device, such as devices B in FIG. 2.

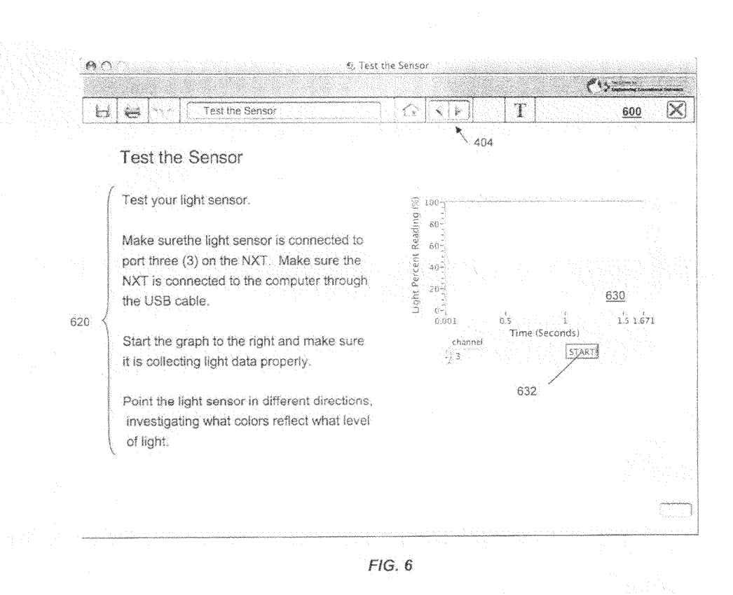

The user can then transition to the next screen 600 of FIG. 6, which is entitled Test the Sensor. Screen 600 also includes instructional text 620. In this screen the user is instructed to test a light sensor. The readings of the light sensor are returned to the workbook and plotted in graph 630. The graphing begins when the user selects the START button 632. In this manner, the user's inputs control the light sensor and the light sensor returns its outputs to the workbook.

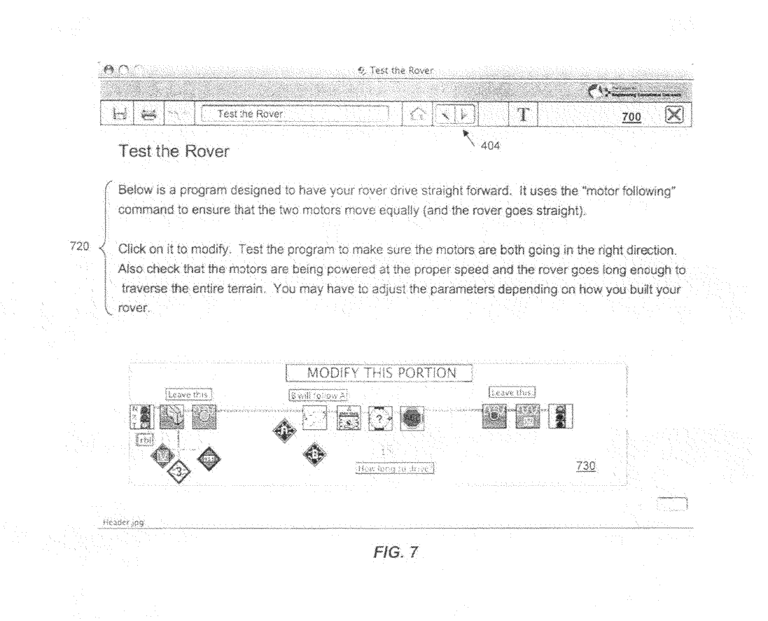

The user can then transition to the next screen 700 of FIG. 7, which is entitled Test the Rover, again using arrows 404. Screen 700 also includes instructional text 720. In this screen the user is instructed to test the user's rover. A sample program 730 is provided that can be downloaded to the user's rover and then executed by the rover. The user has options to modify certain portions of the program, but not others. In this embodiment, the program is a ROBOLAB program that provides a palette of drag-and-drop program element icons, such as those shown in program 730. The ROBOLAB program is known in the art, so not discussed in detail herein. If the user chooses to modify program 730 the ROBOLAB program will open, with a palette of available drag-and-drop program element icons, and the user can perform the appropriate modification. The modified program then becomes part of the user's digital workbook.

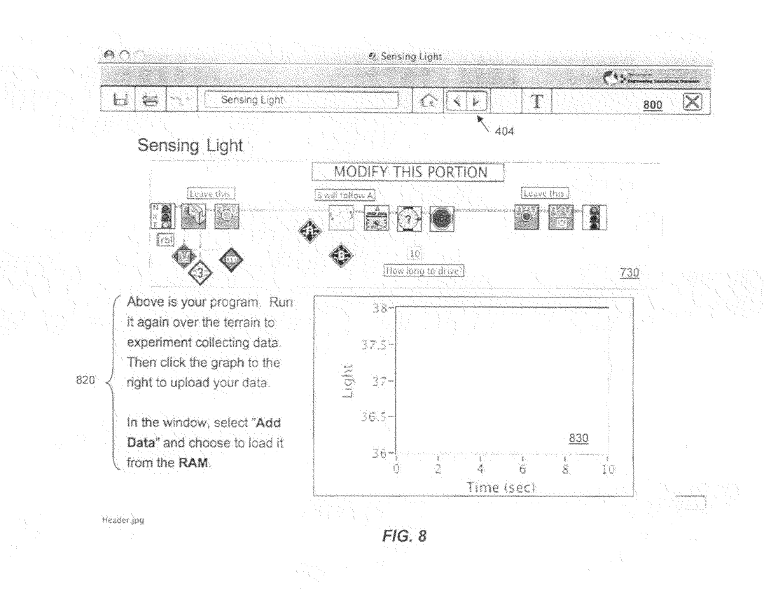

The user can then transition to the next screen 800 of FIG. 8, which is entitled Sensing Light. Screen 800 also includes instructional text 820, as well as program 730. When the program is executed, with the light sensor on, the light sensor data is recorded in graph 830. In this manner, the user's inputs control the rover and the light sensor and the light sensor returns its outputs to the workbook.

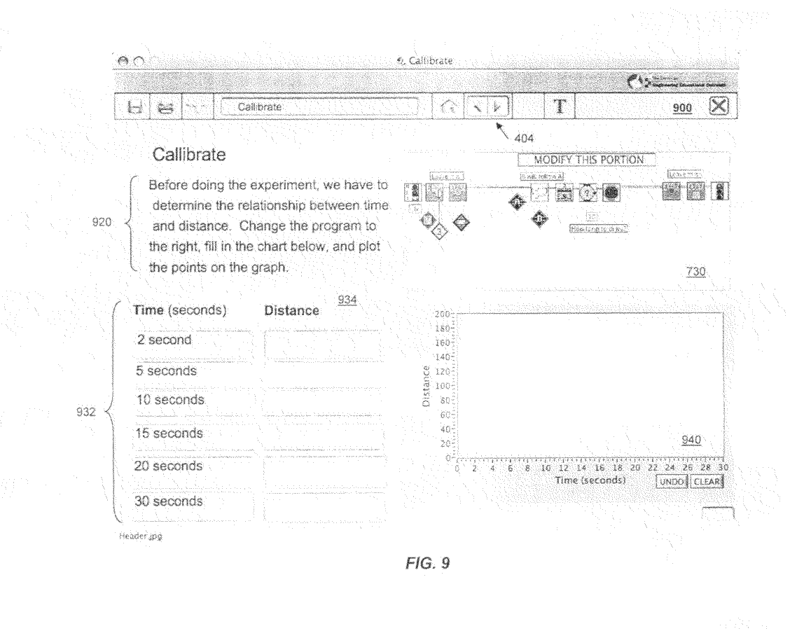

The user can then transition to the next screen 900 of FIG. 9, which is entitled Calibrate. Screen 900 also includes instructional text 920, as well as program 730. The user is instructed to modify program 730 for different time durations 932 and to record the rover distance traveled for each duration. The user types these distances into the input fields 934 under the heading of Distance. Once these entries are made, the user can generate a plot of the data in graph 940. In this manner, the user's inputs and graph become part of the workbook.

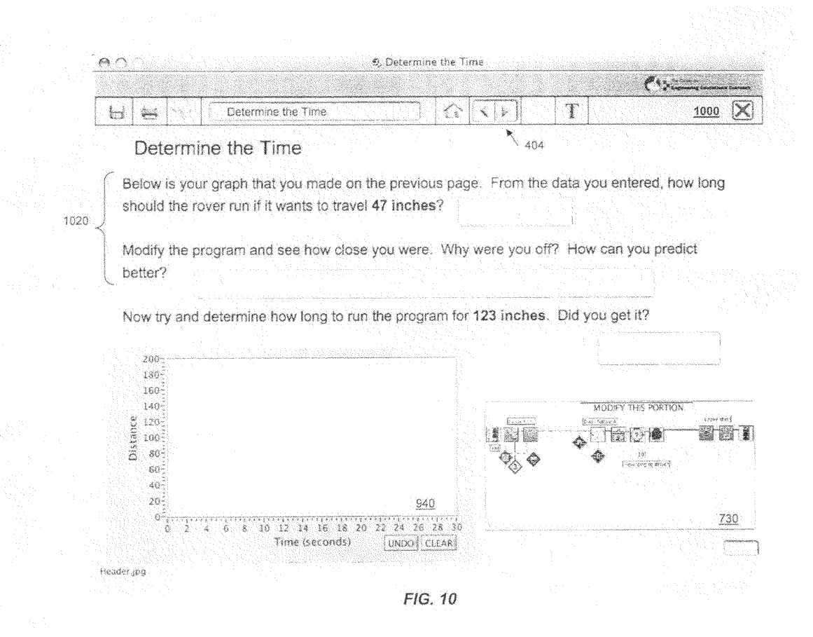

The user can then transition to the next screen 1000 of FIG. 10, which is entitled Determine the Distance, again using arrows 404. Screen 1000 also includes instructional text 1020, which includes questions soliciting user inputs. Program 730 and graph 940 are also included. The user's answer inputs become part of the workbook.

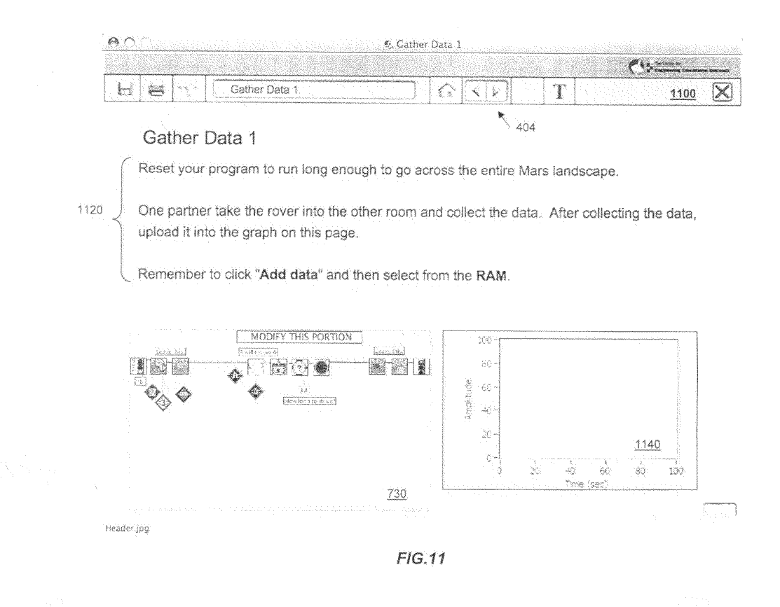

The user can then transition to the next screen 1100 of FIG. 11, which is entitled Gather Data 1. Screen 1100 also includes instructional text 1120, which provides instructions for gathering data by running program 730 and uploading the collected data for plotting in graph 1140. Graph 1140 with plotted data becomes part of the workbook.

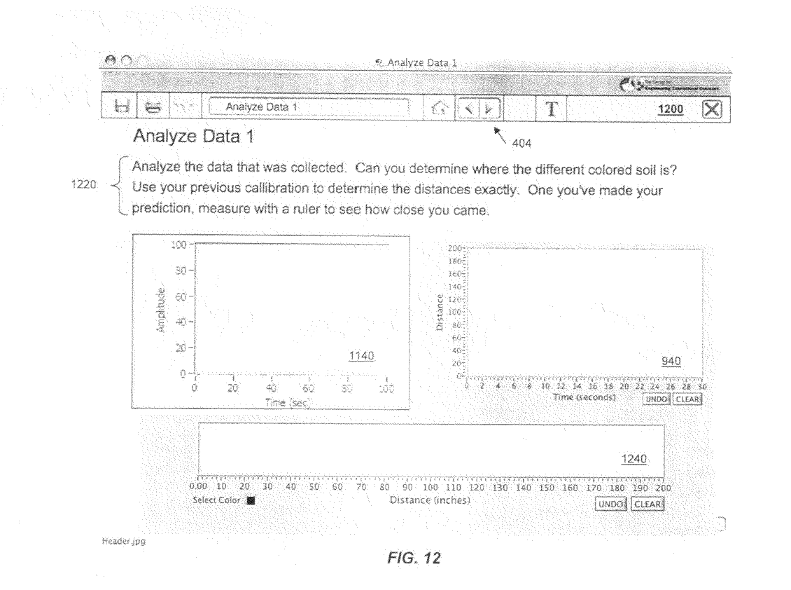

The user can then transition to the next screen 1200 of FIG. 12, which is entitled Analyze Data 1. Screen 1200 also includes instructional text 1220, which provides instructions for analyzing data collected in graphs 940 and 1140. A bar graph 1240 allows a user to input colors representing different color soils traversed by the user's rover. This can be predicted based on the information in graphs 940 and 1140. Graph 1240 with the color data entered by the user becomes part of the workbook.

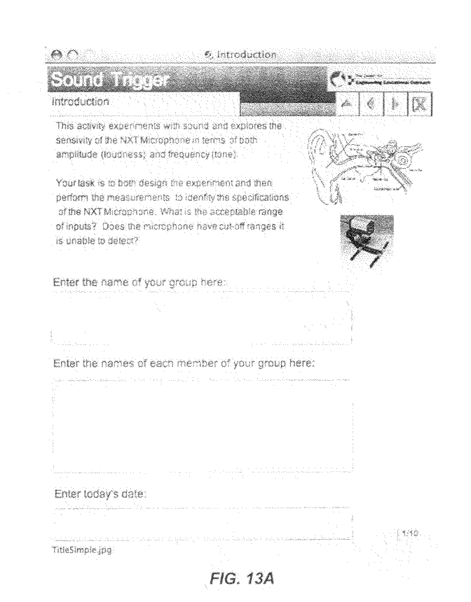

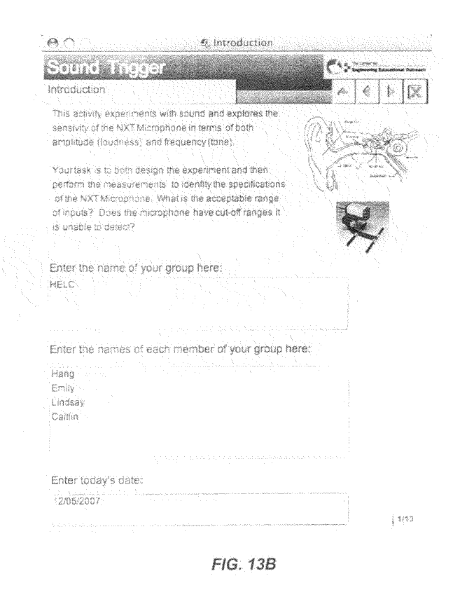

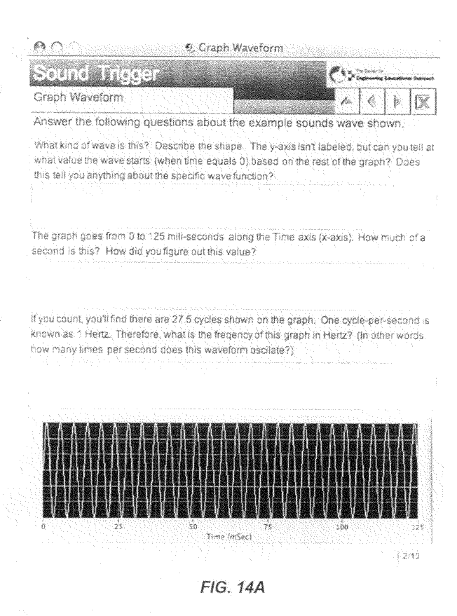

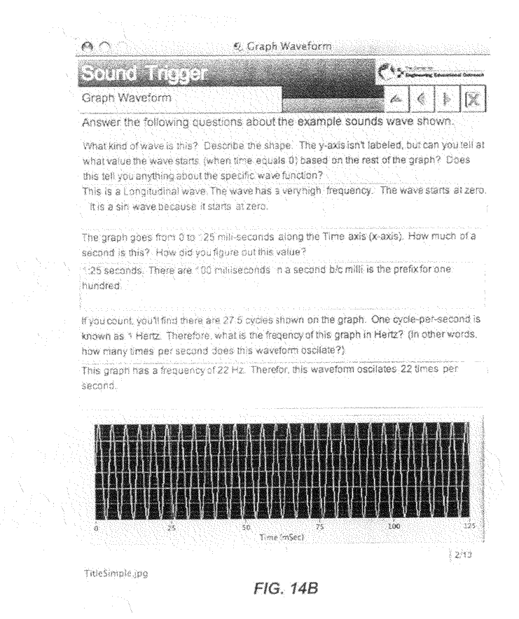

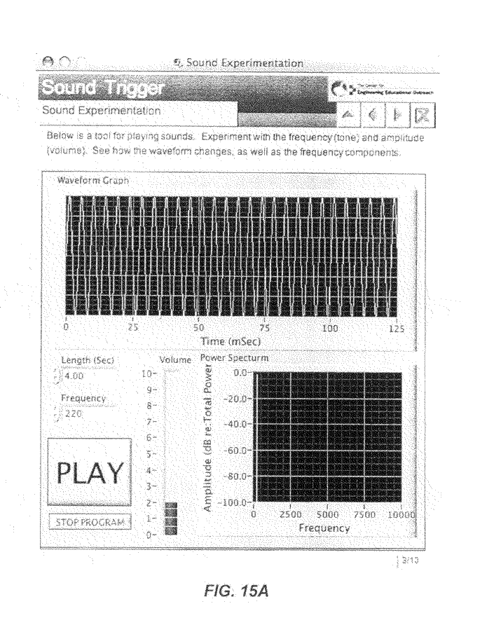

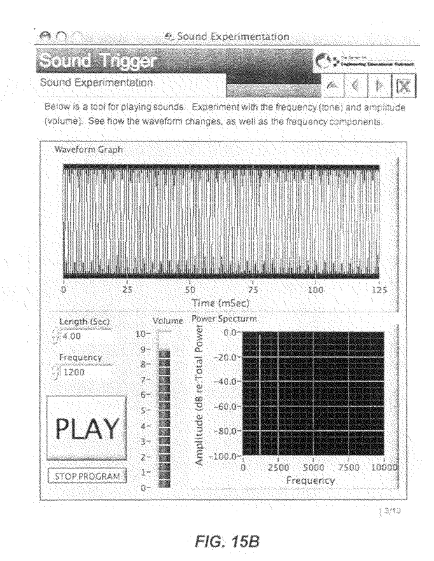

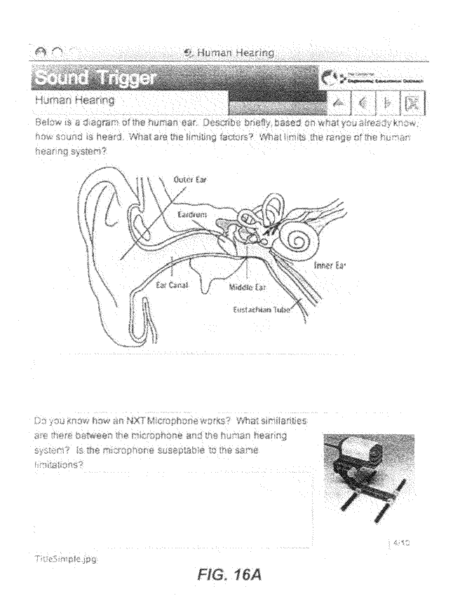

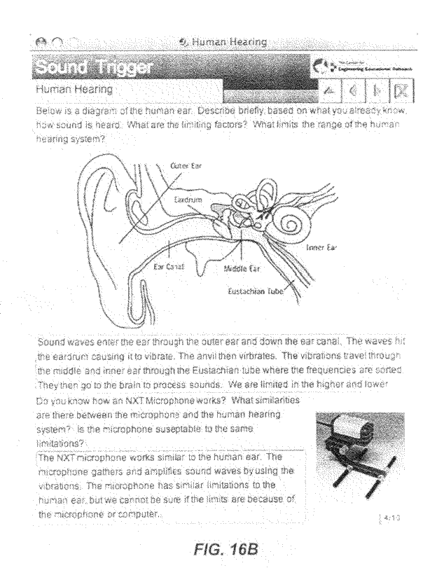

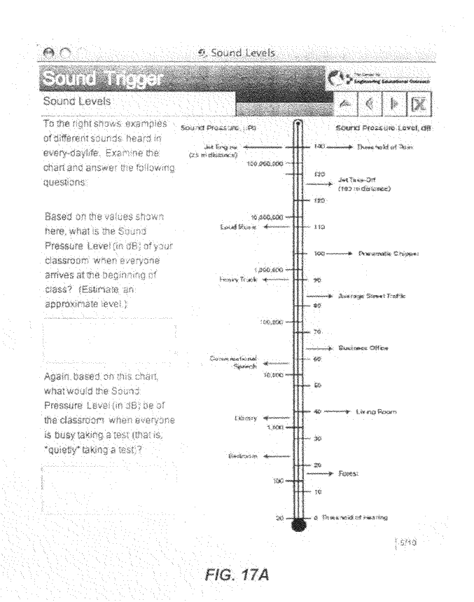

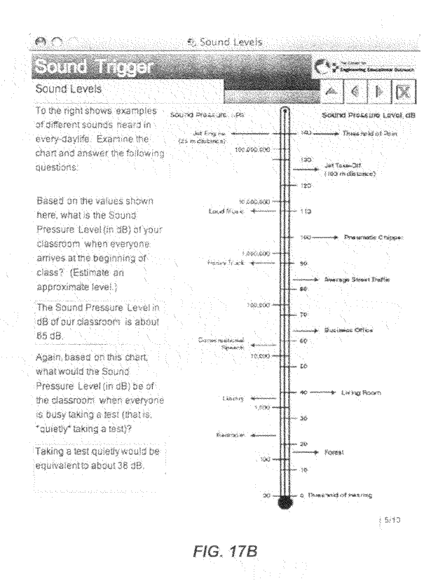

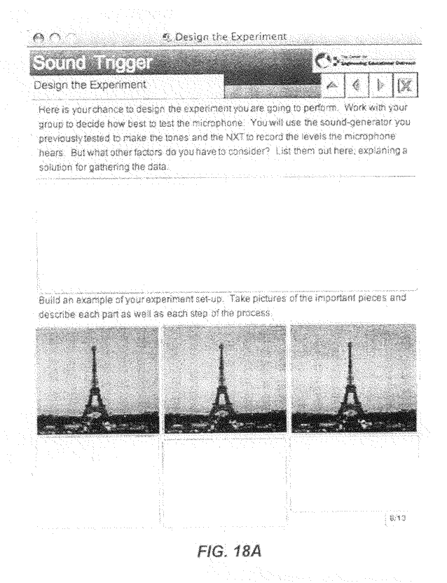

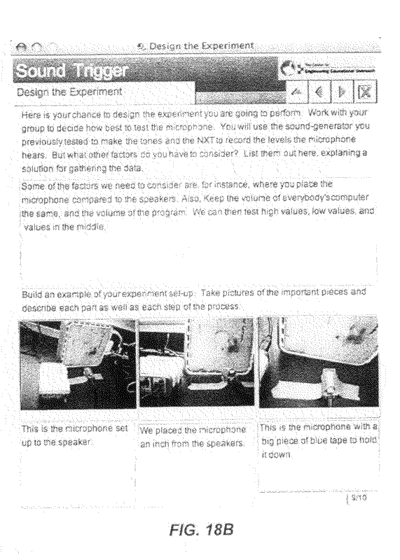

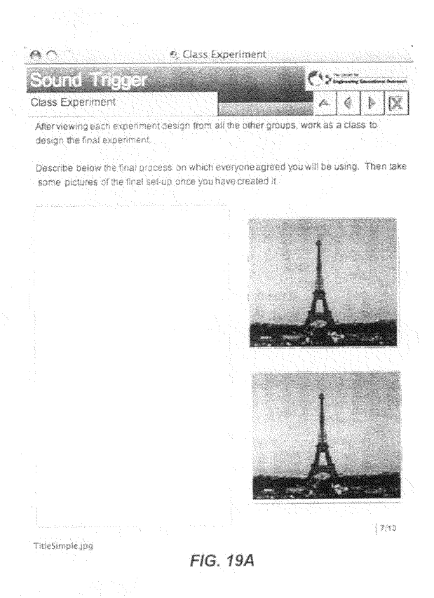

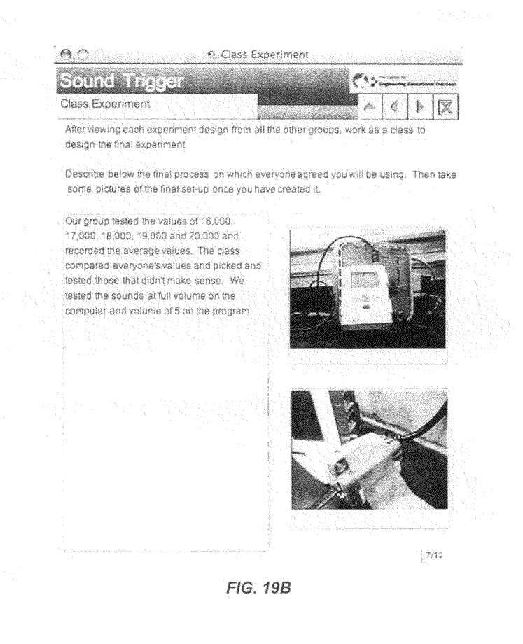

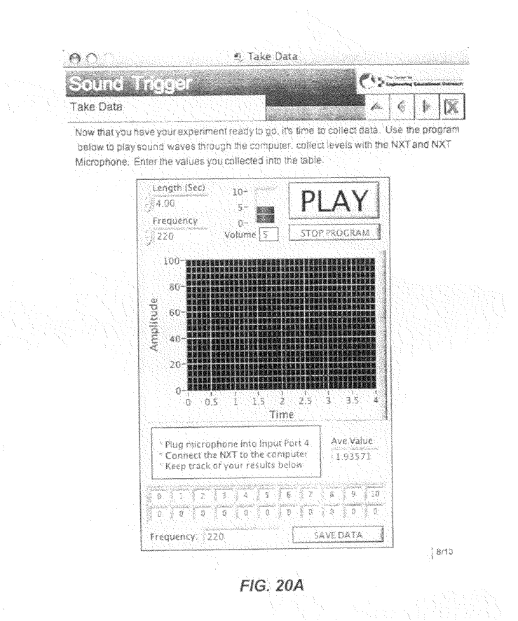

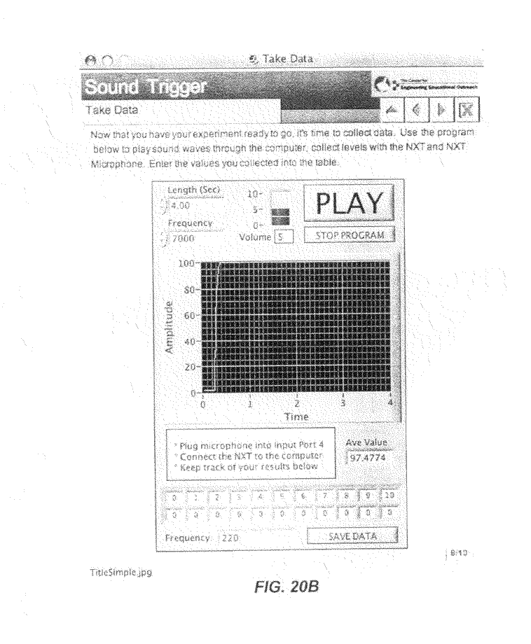

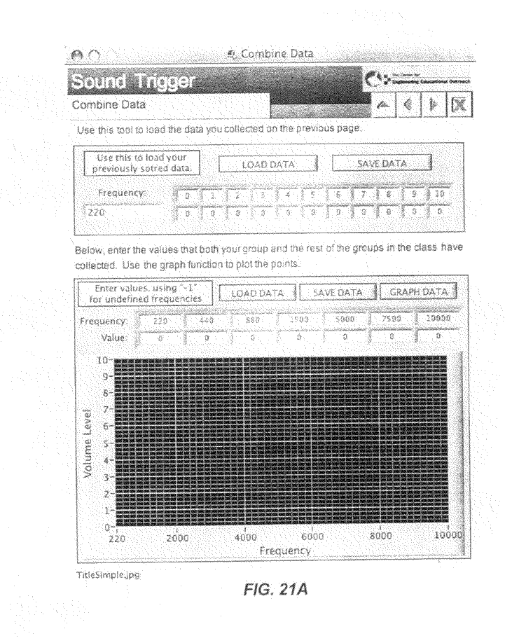

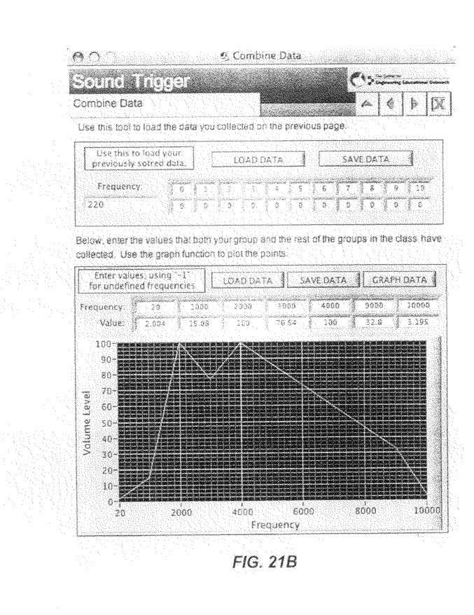

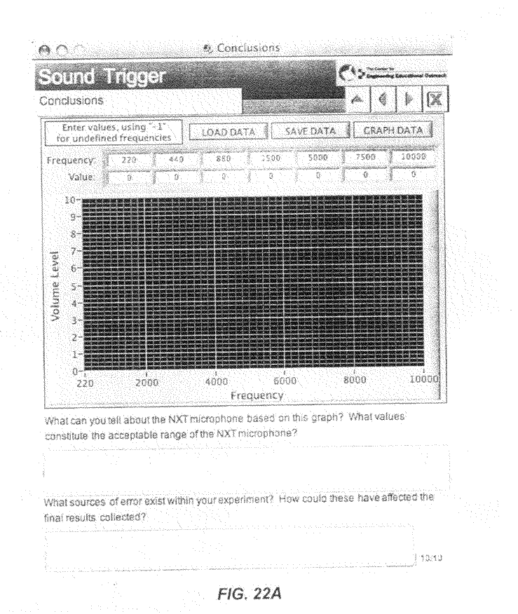

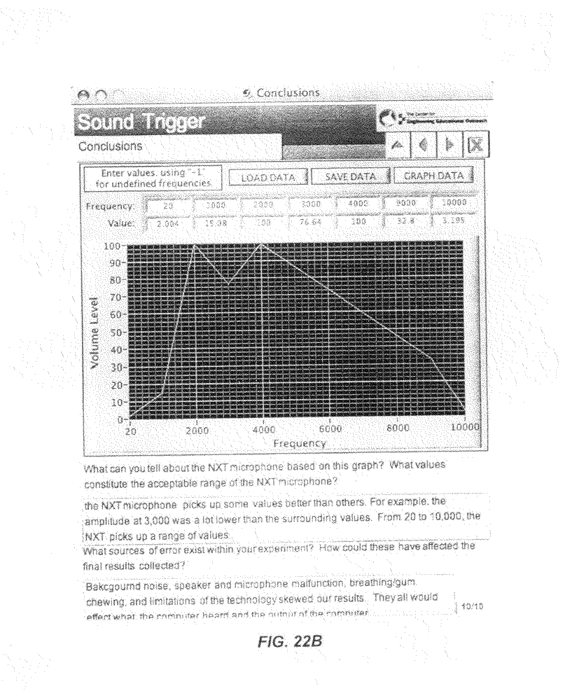

FIGS. 13A-22B are screenshots of an embodiment of screens of the digital workbook 350 of FIG. 3, entitled Sound Trigger. In each case in this set of figures, the first figure (e.g., FIG. 13A) provides the screen without user inputs and outputs from external blocks (i.e., devices, sensors or application). And the corresponding second figure (e.g., FIG. 13B) provides the same screen with user inputs and outputs from external blocks (i.e., devices, sensors or application). Detailed description of FIGS. 13A-22B is omitted for brevity. However, the text included therein in conjunction with the discussion above will be illustrative to those skilled in the art.

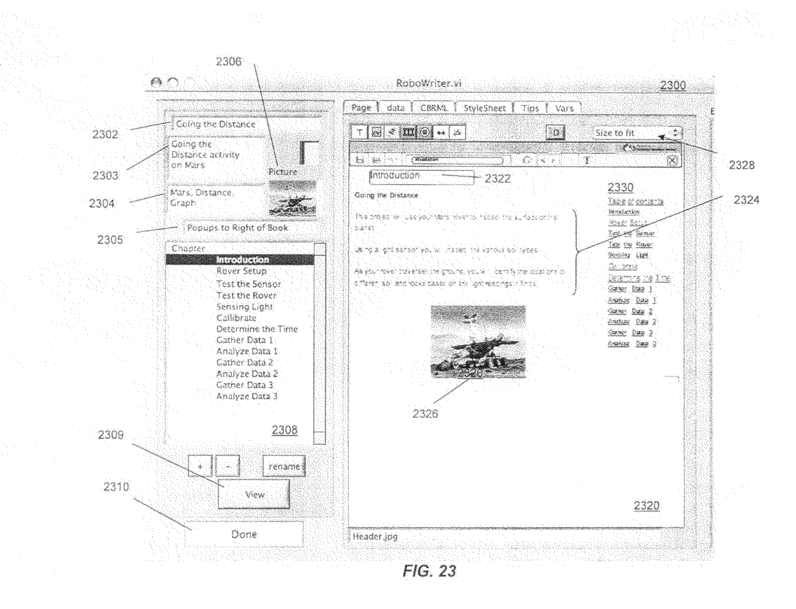

FIG. 23 is a screenshot of an embodiment of a main screen 2300 that can be used by an author for creating a digital workbook. Main screen includes a framework defining several regions for creating a master workbook. In this embodiment, the generation module 112 of FIG. 2 provides underlying functionality via the user interface module 140 to generate a master workbook from the author's inputs.

In this embodiment, main screen 2300 includes a title entry field for text input of a title, here Going the Distance. A graphic definition field 2304 enables an author to add an image 2306. A table of contents section 2308 enables the author to define chapters for the digital workbook.

Selecting a chapter in field 2308 and choosing the View button 2309 causes a page to be rendered in authoring section 2320. Here, the chapter Introduction was selected in section 2308, which is reflected in chapter field 2322 in authoring section 2320. From there, the author can add text, images, and other content—as desired. Here the author typed in text 2324 and added picture 2326. The Table of contents is also presented in authoring section 2320. As will be appreciated by reviewing screen 400 of FIG. 4, ultimately the digital workbook is presented substantially as created in the authoring section 2320 of main screen 2300. When the author is done it can select the Done button 2310.

The other pages of the digital workbook are created in a similar manner, i.e., by selecting the appropriate chapter from section 2308 and adding desired text, graphics, and images.

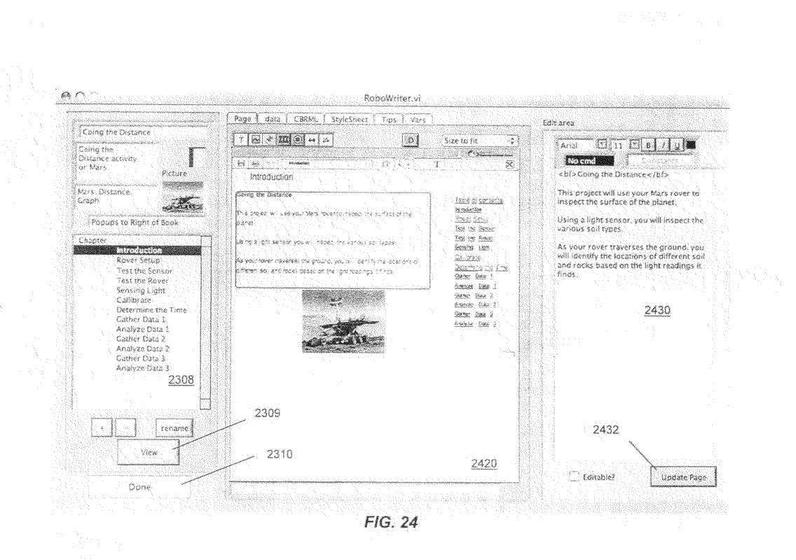

FIG. 24 is a screenshot of an embodiment of an editing screen 2400 that can be used for editing text in the digital workbook. Again, the chapter section 2308 is presented. The appropriate page to be edited is presented in a center section 2420—with the text highlighted. A text edit section 2430 is also provided that shows the text on that page. The user can edit the text in the text edit section and then update the page by selecting the “Update Page” button 2432. When the user is done it can select the Done button 2310.

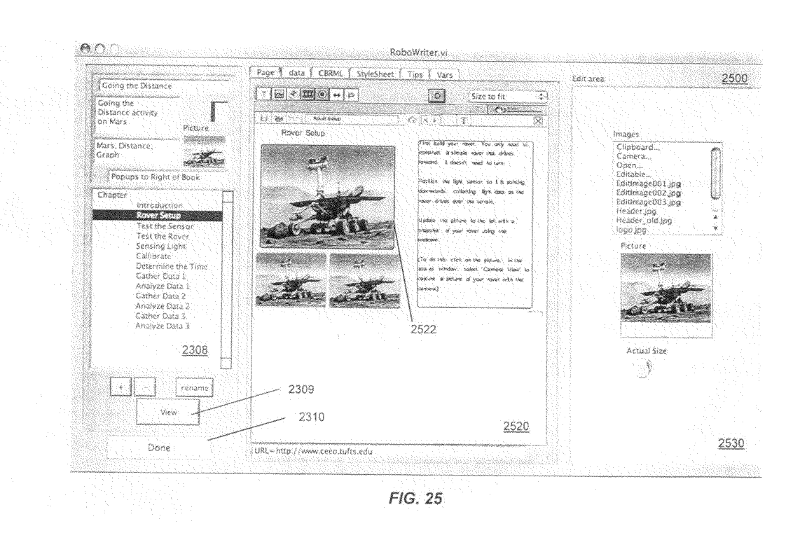

FIG. 25 is a screenshot of an embodiment of an editing screen 2500 that can be used for editing the image in the digital workbook. Again, the chapter section 2308 is presented. Here the Rover Setup chapter has been selected, and is presented in a center section 2520—with the top image 2522 highlighted. An image edit section 2530 is also provided that shows the selected image on that page. Section 2530 also provides a list of available images from the user can select, for example, to change the image 2522 to a different image. When the user is done it can select the Done button 2310.

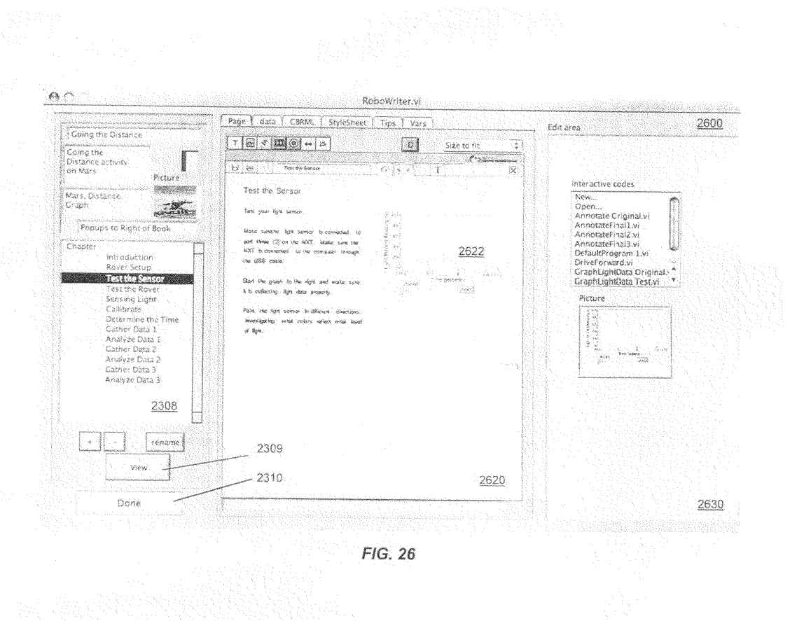

FIG. 26 is a screenshot of an embodiment of an editing screen 2600 that can be used for editing a graph element in the digital workbook. Again, the chapter section 2308 is presented. Here the Test the Sensor chapter has been selected, and is presented in a center section 2620. The only graph element on the page is graph 2622. A graph element edit section 2630 is also provided that shows the graph on that page. Section 2630 also provides a list of available graph elements that the user can select from, for example, to change the graph 2622 to a different image. When the user is done it can select the Done button 2310.

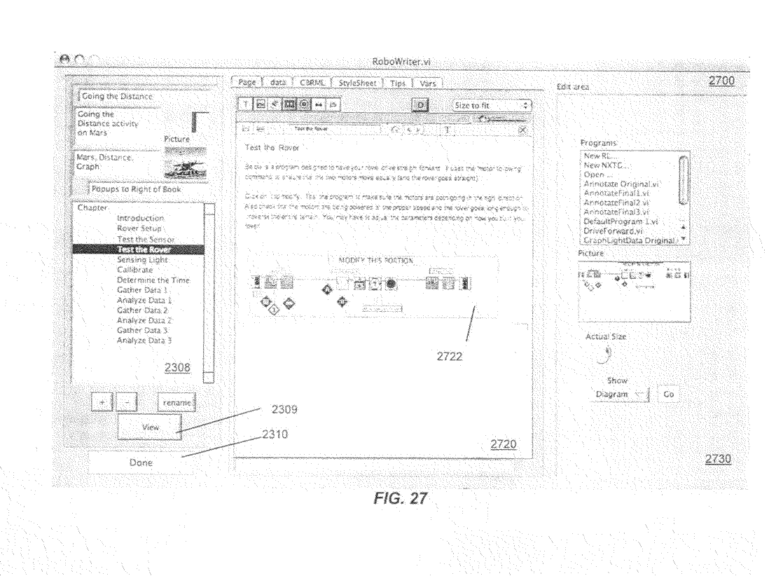

FIG. 27 is a screenshot of an embodiment of an editing screen 2700 that can be used for editing interactive code elements in the digital workbook. Again, the chapter section 2308 is presented. Here the Test the Rover chapter has been selected, and is presented in a center section 2720. The only interactive code element on the page is program 2722. An interactive code element edit section 2730 is also provided that shows the interactive code element on that page. Section 2730 also provides a list of available programs that the user can select from, for example, to change the program 2722 to a different program. When the user is done it can select the Done button 2310.

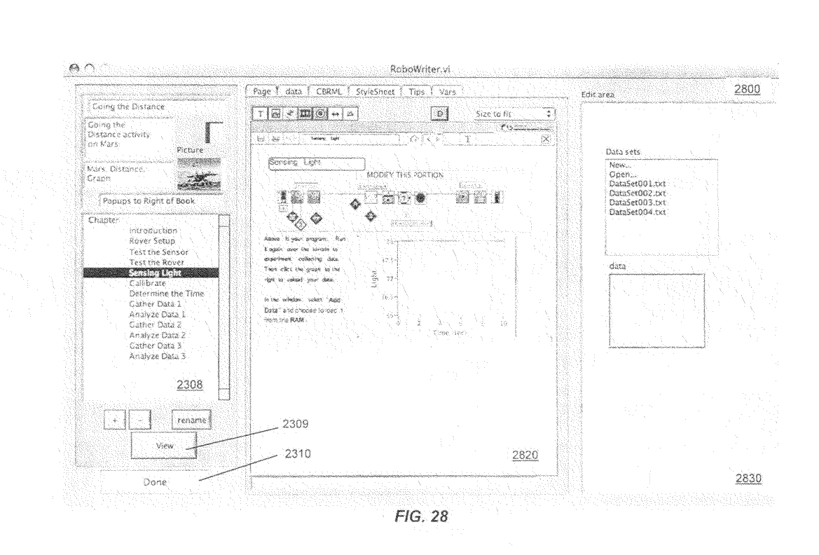

FIG. 28 is a screenshot of an embodiment of an editing screen 2800 that can be used for a data set element in the digital workbook. Again, the chapter section 2308 is presented. Here the Sensing Light chapter has been selected, and is presented in a center section 2820. A data set element edit section 2830 is also provided that shows a list of available data sets from which the user can select. Choosing a data set allows the ultimate user to add a data set to the workbook. When the user is done it can select the Done button 2310.

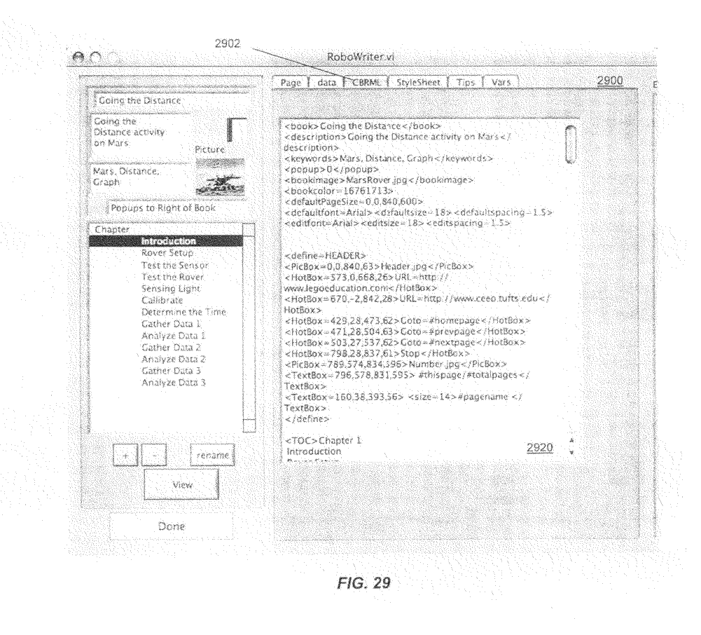

FIG. 29 is a screenshot of main screen 2300 of FIG. 23 with the CBRML tab 2902 selected, here CBRML is an acronym for case based reasoning (CBR) using extensible markup language (XML). A center section 2920 shows the markup language version of the selected Introduction chapter in this case. Here the user can directly edit the markup version of the page. When the user is done it can select the Done button 2310.

While the foregoing has described what are considered to be the best mode and/or other preferred embodiments, it is understood that various modifications can be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

What is claimed is:

1. A digital workbook system comprising:
a workbook module configured to enable an author to generate a digital workbook through a graphical framework configured to enable the author to generate pages within the digital workbook, the pages including:
interfaces to a set of applications; and
mechanisms that facilitate user interaction with the set of applications and recording of user entries and information from the set of applications; and
a storage module configured to store the digital workbook in an electronic library as a master digital workbook.

2. The system of claim 1, wherein the workbook module is configured to enable the author to enter programming instructions to interact with at least one external device via the set of applications through the digital workbook.

3. The system of claim 1, wherein the mechanisms that facilitate user interaction with the set of applications and recording of user entries and information from the set of applications include mechanisms that enable the user to graphically define and interact with a computer program configured to control an external device.

4. The system of claim 1, further comprising:
a collaboration module configured to enable multiple authors to create a digital workbook simultaneously using different computers.

5. The system of claim 1, wherein the pages further comprise information and instructional content including one or more of textual, graphical, audio, or video content.

6. The system of claim 1, wherein the interfaces to the set of applications include application program interfaces that enable the workbook module to communicate with the set of applications.

7. The system of claim 1, further comprising:
an interaction module configured to enable the user to generate and save a unique digital workbook from the master digital workbook and to record the user entries and information from the set of applications as part of the unique digital workbook.

8. A digital workbook system, comprising:
a program interface module configured to communicate with a set of devices;
a workbook module configured to generate a digital workbook from a master digital workbook, the digital workbook comprising content including mechanisms that enable inputs to and receipt of outputs from the set of devices;
a user interface module configured to generate a user interface screen within which the digital workbook is presented; and
a storage module configured to store the digital workbook with user-entered inputs and outputs from the set of devices as part of the content, wherein the digital workbook takes the form of a user specific electronic book that documents the user's interaction therewith.

9. The system of claim 8, wherein at least a portion of the content is dynamic information, including selectable icons and hypertext links.

10. The system of claim 8, wherein the mechanisms enabling input include a palette of drag-and-drop icons representing instructions for programming at least one of the set of devices.

11. The system of claim 8, wherein the mechanisms enabling input include alphanumeric input boxes configured for user data entry.

12. The system of claim 8, wherein the mechanisms enabling input enable at least one of an audio input, a video input, and a camera input.

13. The system of claim 8, wherein the user-entered inputs include user-entered programming instructions passed to the set of devices through the program interface module.

14. The system of claim 8, wherein the mechanisms enabling receipt of outputs from the set of devices include data and information recording mechanisms.

15. The system of claim 8, wherein the mechanisms enabling receipt of outputs from the set of devices include mechanisms for generating a graph from sensor data output from the set of devices.

16. The system of claim 8, further comprising:
a collaboration module configured to enable multiple users to interact with the digital workbook using different computers.

17. The system of claim 16, wherein the digital workbook is an educational lesson or lab and the multiple users includes at least two students.

18. The system of claim 16, wherein the digital workbook is an educational lesson or lab and the multiple users includes a teacher and a student.

19. A computer-based method of creating and storing a digital workbook, the method comprising:
providing an electronic library having at least one master digital workbook;
generating the digital workbook from the master digital workbook, the digital workbook comprising content including mechanisms that enable inputs to and receipt of outputs from a set of applications;
interacting with the set of applications from within the digital workbook; and
storing the digital workbook with user-entered inputs and outputs from the set of applications as part of the content.

20. The method of claim 19, wherein the set of applications controls at least one external device that generate at least some of the outputs.

21. The method of claim 20, wherein the interacting includes programming the at least one external device from within the digital workbook.

22. The method of claim 20, wherein the at least one external device includes at least one programmable device.
